(19) United States
(12) Patent Application Publication
(10) Pub. No.: US 2026/0052495 A1
(43) Pub. Date: Feb. 19, 2026

(54) METHOD OF TRANSMISSION TIMING IN A MULTIPLE TRP SYSTEM, SYSTEM, TERMINAL DEVICE, AND CHIP

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/827,401

(22) Filed: Sep. 6, 2024

Related U.S. Application Data
(63) Continuation of application No. PCT/IB2023/053423, filed on Apr. 4, 2023.
(60) Provisional application No. 63/327,559, filed on Apr. 5, 2022.

(51) Int. Cl. H04W 56/00; H04L 5/00

(52) U.S. Cl. CPC H04W 56/0045; H04L 5/0053

(57) ABSTRACT

Provided is a method for configuring one or more mechanisms for transmitting multiple PUSCH and/or PUCCH towards different TRPs simultaneously in multi-DCI based multi-TRP systems is disclosed. In some implementations, a communication system can configure a terminal device with a multi-TRP transmission mechanism. The terminal device can simultaneously communicate with two different TRPs, a first TRP and a second TRP

### CROSS-REFERENCE TO RELATED APPLICATION(S)

This application is a continuation of International Application No. PCT/IB2023/053423, filed Apr. 4, 2023, which claims priority to U.S. Provisional Patent Application No. 63/327,559, filed Apr. 5, 2022, the entire disclosures of which are incorporated herein by reference.

### TECHNICAL FIELD

This application relates to the communications field, and more specifically, to a method of transmission timing in a multiple TRP system, a system, a terminal device, and a chip.

### BACKGROUND

Rapid growth in computing technology is creating a greater demand for data communication. The increasing demand in turn drives further growth in communication technology. One such technological advance corresponds to multipoint point communications that leverage multiple points/devices to communicate with one device. However, the rapid growth is further increasing demands for higher throughput, which requires additional coordination between the multiple communication points and the corresponding complications.

### BRIEF DESCRIPTION OF THE DRAWINGS

To describe the technical solutions in the implementations of the present technology more clearly, the following briefly describes the accompanying drawings. The accompanying drawings show merely some aspects or implementations of the present technology, and a person of ordinary skill in the art may still derive other drawings from these accompanying drawings without creative efforts.

FIG. 1 illustrates a wireless communication system in accordance with one or more implementations of the present technology.

FIG. 2 illustrates an example multipoint communication scheme in accordance with one or more implementations of the present technology.

FIGS. 3A and 3B illustrate example multipoint coordination schemes in accordance with one or more implementations of the present technology.

FIG. 4A illustrates a flowchart of an example method of adjusting uplink timing in a multi-TRP transmission, in accordance with one or more implementations of the present technology.

FIG. 4B illustrates a diagram of two adjacent uplink transmissions, in accordance with one or more implementations of the present technology.

FIG. 5 illustrates a schematic block diagram of a terminal device in accordance with one or more implementations of the present disclosure.

FIG. 6 illustrates is a schematic block diagram of a system chip in accordance with one or more implementations of the present disclosure.

FIG. 7 illustrates a schematic block diagram of a communications device in accordance with one or more implementations of the present disclosure.

### DETAILED DESCRIPTION

The following describes the technical solutions in the one or more implementations of the present technology. A wireless communication system can coordinate and configure multipoint joint communications to/from terminal devices. For example, the system can include multiple transmission-reception points (TRPs) that are connected to each other through backhaul links (e.g., ideal type or non-ideal type) for coordination. The system can coordinate and configure a terminal device with a multi-TRP transmission mechanism.

Conventional methods only support the function of timing advance for uplink transmission, where a next generation Node B (gNB) sends a special command to a terminal device to enable the terminal device to adjust its uplink transmission so that the uplink transmission arrives at the gNB side at the right timing. The uplink adjustment applies to a Physical Uplink Shared Channel (PUSCH), a Physical Uplink Control Channel (PUCCH), and/or a Sounding Reference Signal (SRS) transmission. The timing advance information is delivered to a terminal device through two methods. The first method is a random-access channel (RACH) response (RAR). The gNB can indicate one timing advance value in the RAR message to the terminal device. The second method is a Media Access Control (MAC) control element (CE) command. The gNB can indicate one timing advance value in a MAC CE command and upon receiving the MAC CE command, the terminal device can be requested to apply the indicated timing advance value. However, conventional schemes cannot overcome the challenges caused by the uplink transmission in multi-TRP system, in that the terminal device sends the uplink channel or SRS towards different TRP with the same timing advance value. The foregoing scheme requires the distance between terminal device and those two different TRPs to be the same.

In contrast to the conventional methods, implementations of the present technology include one or more mechanisms for transmitting multiple PUSCH and/or PUCCH towards different TRPs simultaneously in multi-DCI based multi-TRP systems. For example, the present technology can optimize the uplink transmission in a multi-TRP system.

The system can configure a terminal device with a multi-TRP transmission mechanism. The terminal device can simultaneously communicate with two different TRPs, a first TRP and a second TRP. Although the number of different TRPs is described as two, this is as an illustrative example. The present technology can be easily expanded to other numbers of different TRPs. The terminal device can be indicated with two timing advance values: a first timing advance value and a second timing advance value. The terminal device is requested to adjust the uplink timing for the uplink transmission associated with the first TRP according to the indicated first timing advance value and to adjust the uplink timing for the uplink transmission associated with the second TRP according to the indicated second timing advance value. In first example, the terminal device is indicated to transmit a PUSCH to the first TRP and the terminal device can be requested to adjust the uplink timing for this PUSCH according to the indicated first timing advance value. In a second example, the terminal device is indicated to transmit an SRS to the first TRP and the terminal device can be requested to adjust the uplink timing of the SRS according to the indicated first timing advance value. In a third example, the terminal device is indicated to transmit a PUCCH to the first TRP and the terminal device can be requested to adjust the uplink timing of this PUCCH according to the indicated first timing advance value. In a fourth example, the terminal device is indicated to transmit a PUSCH to the second TRP and the terminal device can be requested to adjust the uplink timing for this PUSCH according to the indicated second timing advance value. In a fifth example, the terminal device is indicated to transmit a SRS to the second TRP and the terminal device can be requested to adjust the uplink timing for the SRS according to the indicated second timing advance value. In a sixth example, the terminal device is indicated to transmit a PUCCH to the second TRP and the terminal device can be requested to adjust the uplink timing for this PUCCH according to the indicated second timing advance value.

In the following description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present technology. References in this description to “an implementation,” “one implementation,” or the like mean that a particular feature, structure, material, or characteristic being described is included in at least one implementation of the described technology. Thus, the appearances of such phrases in this specification do not necessarily all refer to the same implementation. On the other hand, such references are not necessarily mutually exclusive either. Furthermore, the particular features, structures, materials, or characteristics can be combined in any suitable manner in one or more implementations. It is to be understood that the various implementations shown in the figures are merely illustrative representations and are not necessarily drawn to scale.

Several details describing structures or processes that are well-known and often associated with communication systems and subsystems, but that can unnecessarily obscure some significant aspects of the disclosed techniques, are not set forth in the following description for purposes of clarity. Moreover, although the following disclosure sets forth several implementations of different aspects of the present technology, several other implementations can have different configurations or different components than those described in this section. Accordingly, the disclosed techniques can have other implementations with additional elements or without several of the elements described below.

Many implementations or aspects of the technology described below can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium, including a liquid crystal display (LCD). Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The terms “coupled” and “connected,” along with their derivatives, can be used herein to describe structural relationships between components. It should be understood that these terms are not intended as synonyms for each other. Rather, in particular implementations, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both. The term “and/or” in this specification is only an association relationship for describing the associated objects, and indicates that three relationships may exist, for example, A and/or B may indicate the following three cases: A exists separately, both A and B exist, and B exists separately. In addition, the character “/” in this specification generally indicates an “or” relationship between the associated objects.

### Suitable Environments

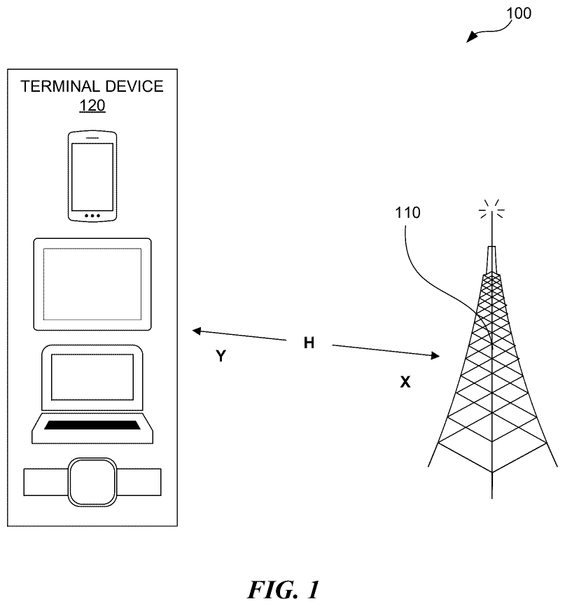

FIG. 1 illustrates a wireless communication system 100 in accordance with one or more implementations of the present technology. As shown in FIG. 1, the wireless communication system 100 can include a network device 110. The network device 110 can include circuitry configured to provide communication coverage for a specific geographic area. Some examples of the network device 110 can include: a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP). Additional examples of the network device 110 can include a relay station, an access point, an in-vehicle device, a wearable device, and the like. The network device 110 can include other wireless connection devices for communications networks such as: a Global System for Mobile Communications (GSM) network, a Code Division Multiple Access (CDMA) network, a Wideband CDMA (WCDMA) network, a Long-Term Evolution (LTE) network, a cloud radio access network (Cloud Radio Access Network, CRAN), an Institute of Electrical and Electronics Engineers (IEEE) 802.11-based networks (e.g., a WiFi network), an Internet of Things (IoT) network, a device-to-device (D2D) network, a next-generation network (e.g., a Fifth Generation (5G) network), a future evolved public land mobile network (Public Land Mobile Network, PLMN), or the like. Optionally, a 5G system or network may be further referred to as a new radio (New Radio, NR) system or network. The network device 110 can further include the TRP.

Additionally or alternatively, the wireless communication system 100 can include a terminal device 120. The terminal device 120 can be an end-user device configured to facilitate wireless communication. The terminal device 120 can be configured to wirelessly connect to the network device 110 (via, e.g., a wireless channel) according to one or more corresponding communication protocols/standards. The terminal device 120 may be mobile or fixed. The terminal device 120 can be an access terminal, a user equipment (UE), a user unit, a user station, a mobile site, a mobile station, a remote station, a remote terminal, a mobile device, a user terminal, a terminal, a wireless communications device, a user agent, or a user apparatus. Some examples of the terminal device 120 can include: a cellular phone, a smart phone, a cordless phone, a Session Initiation Protocol (SIP) phone, a wireless local loop (Wireless Local Loop, WLL) station, a personal digital assistant (PDA), a handheld device having a wireless communication function, a computing device or another processing device connected to a wireless modem, an in-vehicle device, a wearable device, an IoT device, a terminal device in a future 5G network, a terminal device in a future evolved PLMN, or the like.

Communications between the network device 110 and the terminal device 120 can experience changes as the corresponding signals travel through a medium or a channel between the devices. In other words, a received signal (Y) may be different than a transmitted signal (X) due to the effects (e.g., fading, interferences, Doppler effects, delays, noises, and/or the like) of traversing through a channel (H).

For illustrative purposes, FIG. 1 illustrates the wireless communication system 100 via the network device 110 and the terminal device 120. However, it is understood that the wireless communication system 100 can include additional/other devices, such as additional instances of the network device 110 and/or the terminal device 120, a network controller, a mobility management entity, etc.

### Multipoint Joint Communication

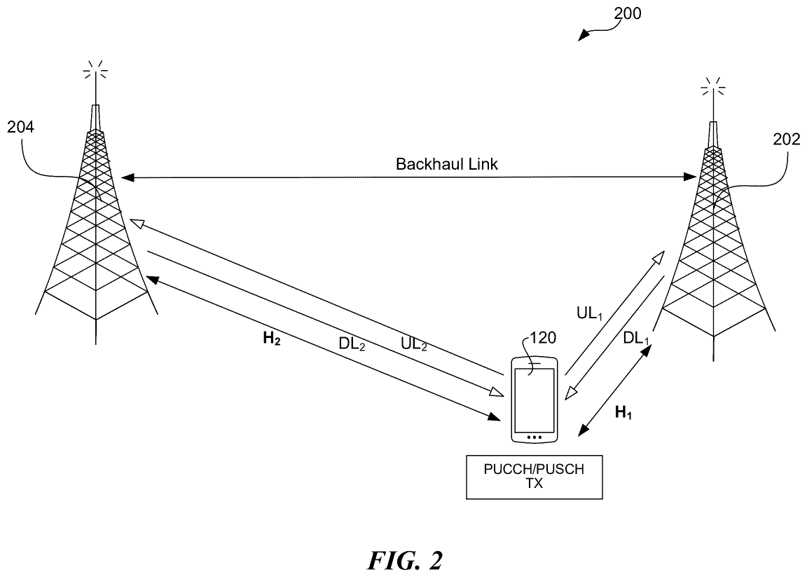

FIG. 2 illustrates an example multipoint communication scheme 200 in accordance with one or more implementations of the present technology. The communication system 100 can use multiple TRPs (e.g., instances of the network device 110, such as gNBs) to communicate with one terminal device 120. For example, a first TRP 202 and a second TRP 204 can be coupled to the terminal device. The first TRP 202 and the second TRP 204 can be coupled to each other via a backhaul link. Accordingly, the multiple TRPs can communicate with each other to coordinate the joint communications with the terminal device 120.

For context, the backhaul link can be ideal or non-ideal. When the TRPs are connected via an ideal backhaul link, the TRPs can exchange dynamic scheduling information (e.g., regarding physical downlink shared channel (PDSCH) communications) with short latency. As such, the TRPs can leverage the ideal backhaul link to coordinate the downlink transmissions per each transmission. In contrast, when the TRPs are connected via a non-ideal backhaul link, the information exchanged between the TRPs can have a relatively greater latency. As such, the TRPs may coordinate the communications using a semi-static or a static scheme.

In non-coherent joint transmission, different TRPs can independently use different physical downlink control channels (PDCCH) to schedule the PDSCH transmissions. Each TRP can send one DCI to schedule one PDSCH transmission. Accordingly, the different TRPs can schedule the corresponding PDSCHs in same or different slots. As a result, two different PDSCH transmission from different TRPs can be fully overlapped or partially overlapped in PDSCH resource allocation. To support multi-TRP based non-coherent joint transmission, the communication system 100 may request the terminal device 120 to receive PDCCH from multiple TRPs. For each PDSCH transmission, the terminal device 120 can provide feedback information (e.g., a Hybrid ARQ acknowledge (HARQ-ACK)) to the network. In multi-TRP transmissions, the terminal device 120 can provide the feedback for each PDSCH transmission to the corresponding TRP. The terminal device 120 may also receive the PDSCH transmission from one TRP and provide the corresponding feedback to another TRP (e.g., a designated TRP).

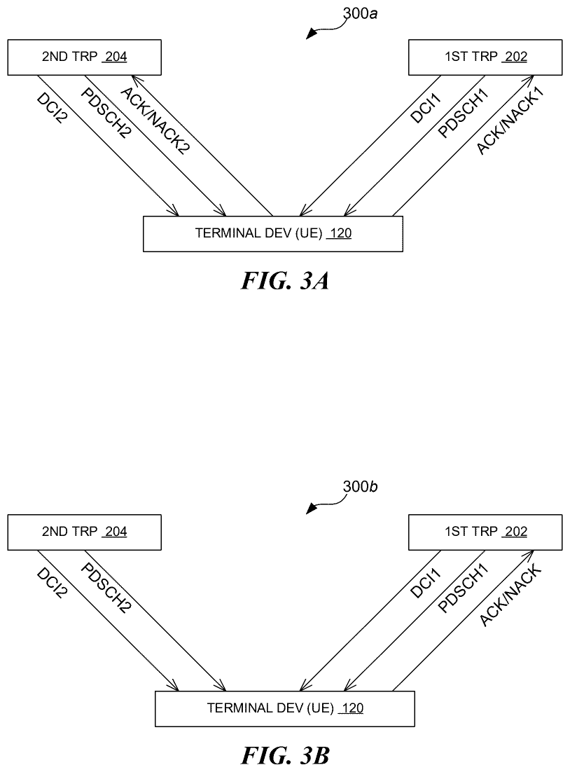

FIGS. 3A and 3B illustrate example multipoint coordination schemes 300a and 300b, respectively, in accordance with one or more implementations of the present technology. The coordination schemes 300a and 300b can represent different combinations for the feedbacks described above.

For the coordination schemes 300a and 300b, the terminal device 120 can receive or establish PDSCHs based on non-coherent joint transmission from the first TRP 202 and the second TRP 204. For example, the first TRP 202 can send a first configuration command (e.g., a DCI1) to schedule the transmission of a first communication (PDSCH1) to the terminal device 120. Also, the second TRP 204 can send a second configuration command (e.g., a DCI2) to schedule the transmission of a second communication (PDSCH2) to the terminal device 120.

Accordingly, the terminal device 120 can receive and decode the separate configuration commands (e.g., DCI1 and DCI2). The terminal device 120 can use the separate decoding results of the separate configuration commands to receive and decode the corresponding communications (e.g., PDSCH1 and PDSCH2, respectively). In other words, the terminal device 120 can (1) use the decoding results of DCI1 to receive and decode PDSCH1 and (2) use the decoding results of DCI2 to receive and decode PDSCH2.

In some implementations, the multiple TRPs can use different control resource sets (CORESETs) and search spaces to transmit the configuration commands (DCI) for scheduling the communication, such as the PDSCH transmission. As such, the communication system 100 or the network can configure multiple CORESETs and search spaces. Each TRP can be associated with one or more CORESETs and the related search spaces, which can be used to transmit the corresponding configuration command to the terminal device 120. The terminal device 120 can be requested to decode the configuration command in the CORESETs associated with one or more (e.g., either, any, or all) TRPs to obtain the scheduling information.

The terminal device 120 can provide feedback information, such as using HARQ-ACK/NACK, back to one or more TRPs. The feedback information can describe a quality of the received information (e.g., the PDSCH communication), the corresponding channel, and/or a processing success/failure associated with the received information. For the example scheme 300a, the terminal device 120 can report separate feedback information to each TRP. In other words, the terminal device 120 can report (1) a first feedback (ACK/NACK1) to the first TRP 202 and (2) a second feedback (ACK/NACK2) to the second TRP 204. For the example scheme 300b, the terminal device 120 report a common feedback information for both or all communications (e.g., PDSCH1 and PDSCH2) to one/designated TRP. The example scheme 300b can correspond to an ideal backhaul link between the first TRP 202 and the second TRP 204.

Conventional systems only support the function of timing advance for uplink transmission, where a next generation Node B (gNB) sends a special command to a terminal device to enable the terminal device to adjust its uplink transmission so that the uplink transmission arrives at the gNB side at the right timing. The uplink adjustment applies to a Physical Uplink Shared Channel (PUSCH), a Physical Uplink Control Channel (PUCCH), and/or a Sounding Reference Signal (SRS) transmission. The timing advance information is delivered to a terminal device through two methods. The first method is a random-access channel (RACH) response (RAR). The gNB can indicate one timing advance value in the RAR message to the terminal device. The second method is a Media Access Control (MAC) control element (CE) command. The gNB can indicate one timing advance value in a MAC CE command and upon receiving the MAC CE command, the terminal device can be requested to apply the indicated timing advance value. However, conventional schemes cannot overcome the challenges caused by the uplink transmission in multi-TRP system, in that the terminal device sends the uplink channel or SRS towards different TRP with the same timing advance value. That requires the distance between terminal device and those two different TRPs to be same.

In contrast, the communication system 100 (via, e.g., the multipoint communication scheme 200) can include one or more mechanisms for transmitting multiple PUSCH and/or PUCCH towards different TRPs simultaneously in multi-DCI based multi-TRP systems. The communication system 100 can configure a terminal device with a multi-TRP transmission mechanism. The terminal device can simultaneously communicate with two different TRPs, such as a first TRP and a second TRP.

### Example Operational Flow

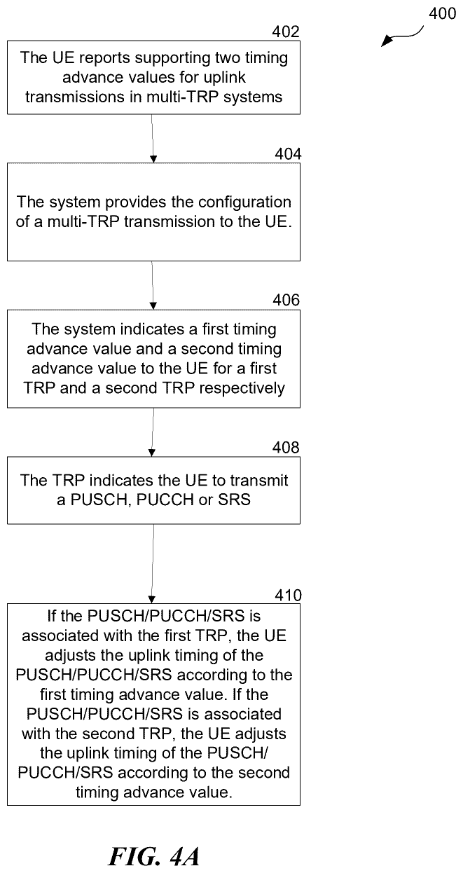

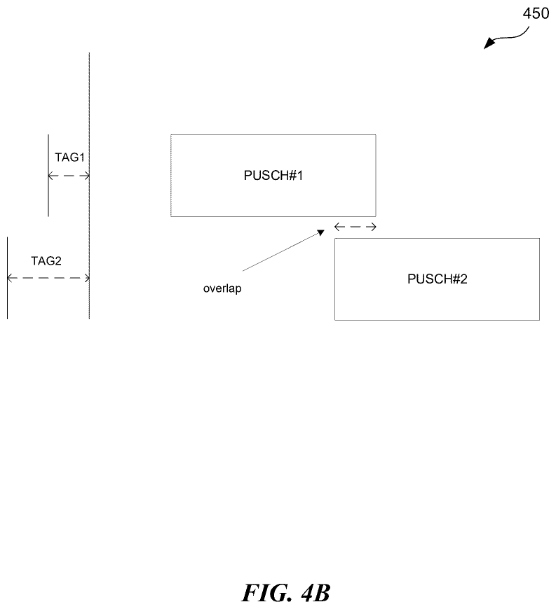

FIG. 4A is a flowchart of an example method 400 of adjusting uplink timing in a multi-TRP transmission, in accordance with one or more implementations of the present technology. The method 400 can be implemented by a system (e.g., the communication system 100 of FIG. 1 and/or one or more devices therein, such as the terminal device 120 of FIG. 1, the network device 110 of FIG. 1, the first TRP 202 of FIG. 2, and/or the second TRP 204 of FIG. 2). The method 400 can correspond to one or more of aspects of transmission timing in a multiple TRP system for the present technology described herein. For example, method 400 corresponds to adjusting uplink timing for a PUSCH/PUCCH/SRS in a multi-TRP transmission.

The system can configure a terminal device (e.g., terminal device 120 of FIG. 1) with a multi-TRP transmission mechanism. The terminal device can simultaneously communicate with two different TRPs (e.g., the first TRP 202 and/or the second TRP 204). The terminal device can be indicated with two timing advance values: a first timing advance value and a second timing advance value. The terminal device is requested to adjust the uplink timing for the uplink transmission associated with the first TRP according to the indicated first timing advance value and to adjust the uplink timing for the uplink transmission associated with the second TRP according to the indicated second timing advance value.

In first example, the terminal device is indicated to transmit a PUSCH to the first TRP and the terminal device can be requested to adjust the uplink timing for this PUSCH according to the indicated first timing advance value. In a second example, the terminal device is indicated to transmit an SRS to the first TRP and the terminal device can be requested to adjust the uplink timing of the SRS according to the indicated first timing advance value. In a third example, the terminal device is indicated to transmit a PUCCH to the first TRP and the terminal device can be requested to adjust the uplink timing of this PUCCH according to the indicated first timing advance value. In a fourth example, the terminal device is indicated to transmit a PUSCH to the second TRP and the terminal device can be requested to adjust the uplink timing for this PUSCH according to the indicated second timing advance value. In a fifth example, the terminal device is indicated to transmit a SRS to the second TRP and the terminal device can be requested to adjust the uplink timing for the SRS according to the indicated second timing advance value. In a sixth example, the terminal device is indicated to transmit a PUCCH to the second TRP and the terminal device can be requested to adjust the uplink timing for this PUCCH according to the indicated second timing advance value.

At block 402, the terminal device can report a capability of supporting two different timing advance values for uplink transmissions in multi-TRP systems. The terminal device can report supporting two different/separate timing advance values for an uplink transmission in a multi-DCI based multi-TRP transmission. In an example, the terminal device can report the capability of: supporting two different/separate timing advance values on uplink transmission in multi-DCI based multi-TRP transmission; and supporting simultaneous uplink transmissions with two different/separate timing advances in one serving cell.

At block 404, the system provides the configuration of a multi-TRP transmission to the terminal device. To support using different timing advance values on an uplink transmission associated with different TRPs in a multi-TRP system, a serving cell can be associated with two timing advance groups (TAGs). Each TAG is associated with the uplink transmission of one TRP in the multi-TRP transmission. The terminal device can be provided with a list of TAG configurations in radio resource control (RRC) signaling. Each TAG configuration contains a TAG identifier/indicator (ID) that is the identifier of the TAG and a time alignment timer for the TAG. The terminal device can be indicated with two TAG-IDs that identify two TAGs for the multi-TRP transmission.

In a first example, the system provides the terminal device with the configuration of a first serving cell. In the configuration of the first serving cell, the terminal device can be provided with two TAG-IDs: a first TAG-ID and a second TAG-ID, which are used to indicate two TAGs that are associated with the first serving cell. During a multi-TRP transmission, the first TAG-ID can be associated with the uplink transmission associated with a first TRP and the second TAG-ID can be associated with the uplink transmission associated with a second TRP.

In a second example, the second TAG-ID can be configured in the configuration of one downlink bandwidth part (BWP) and the first TAG-ID is provided in the configuration of the serving cell. For example, in the configuration of a first serving cell, a first TAG-ID is provided. In the configuration of the first serving cell, a first downlink BWP is configured, and the configuration of the first downlink BWP provides a second TAG-ID. If the multi-TRP transmission is configured in the first downlink BWP, the terminal device can determine that the first TAG-ID is associated with the uplink transmission associated with a first TRP and the second TAG-ID is associated with the uplink transmission associated with a second TRP.

In a third example, the second TAG-ID can be configured in the configuration of one uplink BWP and the first TAG-ID is provided in the configuration of the serving cell. For example, in the configuration of a first serving cell, a first TAG-ID is provided. In the configuration of the first serving cell, a first uplink BWP is configured, and the configuration of the first uplink BWP can provide a second TAG-ID. If the multi-TRP transmission is configured, the terminal device can determine that the first TAG-ID is associated with the uplink transmission associated with a first TRP and the second TAG-ID is associated with the uplink transmission associated with a second TRP.

At block 406, the system indicates a first timing advance value and a second timing advance value to the terminal device for a first TRP and a second TRP respectively. A gNB (e.g., the network device 110 of FIG. 1, the first TRP 202 of FIG. 2, and/or the second TRP 204 of FIG. 2) can provide a timing advance command for a TAG through a MAC CE command. Upon the reception of a timing advance command for a first TAG, the terminal device adjusts uplink timing for PUSCH/PUCCH/SRS transmissions that are associated with the TRP. The TRP is associated with the first TAG based on a value of N_{TA,offset}. The value is associated with the TRP and based on the received timing advance command of the first TAG. The value of N_{TA,offset} can have the following alternatives.

In a first alternative, all the TRPs share the same value of N_{TA,offset}. For example, the configuration of a serving cell can provide one parameter n-TimingAdvanceOffset that provides the value of N_{TA,offset}. And the terminal device can be requested to apply this value of N_{TA,offset} on all the transmission of PUSCH/PUCCH/SRS in a serving cell with the multi-TRP transmission.

In a second alternative, the terminal device can be indicated with two different/separate values of N_{TA,offset} for a multi-TRP transmission. For example, in the configuration of a serving cell, the terminal device can be provided with two parameters: n-TimingAdvanceOffset and n-TimingAdvanceOffset-2nd that provide two values of N_{TA,offset}. In multi-TRP transmission, terminal device can be requested to apply the value of N_{TA,offset} indicated by parameter n-TimingAdvanceOffset for PUSCH/PUCCH/SRS associated with a first TRP and apply the value of N_{TA,offset} indicated by parameter n-TimingAdvanceOffset-2nd for PUSCH/PUCCH/SRS associated with a second TRP in a serving cell with the multi-TRP transmission.

In a third alternative, the terminal device can be indicated with two different/separate values of N_{TA,offset} for a multi-TRP transmission. For example, in the configuration of a serving cell, the terminal device can be provided with one parameter: n-TimingAdvanceOffset provide a first values of N_{TA,offset} and in the configuration of downlink BWP, the terminal device can be provided with one parameter n-TimingAdvanceOffset-2nd that provide a second value of N_{TA,offset}. In a multi-TRP transmission, the terminal device can be requested to apply the value of N_{TA,offset} indicated by parameter n-TimingAdvanceOffset for a PUSCH/PUCCH/SRS associated with a first TRP and apply the value of N_{TA,offset} indicated by parameter n-TimingAdvanceOffset-2nd for the PUSCH/PUCCH/SRS associated with a second TRP in a serving cell with multi-TRP transmission.

In a fourth alternative, the terminal device can be indicated with two different/separate values of N_{TA,offset} for a multi-TRP transmission. For example, in the configuration of a serving cell, the terminal device can be provided with one parameter: n-TimingAdvanceOffset provide a first values of N_{TA,offset} and in the configuration of uplink BWP, the terminal device can be provided with one parameter n-TimingAdvanceOffset-2nd that provide a second value of N_{TA,offset}. In the multi-TRP transmission, terminal device can be requested to apply the value of N_{TA,offset} indicated by parameter n-TimingAdvanceOffset for PUSCH/PUCCH/SRS associated with a first TRP and apply the value of N_{TA,offset} indicated by parameter n-TimingAdvanceOffset-2nd for PUSCH/PUCCH/SRS associated with a second TRP in a serving cell with the multi-TRP transmission.

The gNB can use MAC CE command to indicate a timing advance command for a TAG to the terminal device. Table 1 is an example of MAC CE command for indicating timing advance command:

TABLE 1

| | | |
|---|---|---|
| TAG ID | Timing Advance Command | Oct 1 |

where, the field of TAG ID indicates the TAG identity of the addressed TAG and the field of Timing Advance Command indicates an index value used to control the amount of timing adjustment. In this example, the field of TAG ID only has two bits. Thus, this MAC CE can only support up to 4 TAGs where the TAG identity can be 0, 1, 2, or 3. To support multi-TRP transmission in the system, maximal number of TAGs=4 might not be sufficient since in each serving cell, two different TAGs are needed. Thus, a new MAC CE command is needed for timing advance command indication in this case.

In a first example, a secondary MAC CE command is used for additional timing advance command indication. Table 2 is an example of the secondary MAC CE is shown below:

TABLE 2

| | | |
|---|---|---|
| 2^{nd} TAG ID | Timing Advance Command | Oct 1 |

where the field of “2nd TAG ID” indicates the information of a TAG ID and the terminal device can calculate the TAG ID as TAG ID=the value of “2nd TAG ID”+4. And the field of Timing Advance Command indicates an index value used to control the amount of timing adjustment for the TAG with TAG ID=the value of “2nd TAG ID”+4.

In a second example, a MAC CE with a TAG ID field with more than 2 bits to support the new function of more TAGS is used. Table 3 is an example of MAC CE command is shown below:

TABLE 3

| | | |
|---|---|---|
| TAGID | Reserved bits | Oct 1 |

| | |
|---|---|
| Timing Advance Command | Oct 2 |

In a third example, a MAC CE with a bitmap that is used to indicate each TAG is used to indicate timing advance command for TAG. Table 4 is an example of MAC CE command design is shown below:

TABLE 4

| | | | | | | | | |
|---|---|---|---|---|---|---|---|---|
| b0 | b1 | b2 | b3 | b4 | b5 | b6 | b7 | Oct 1 |

| | |
|---|---|
| Timing Advance Command | Oct 2 |

where each bit of b0˜b7 can be used to represent one TAG. Setting the value of bi (i=0˜7)=1 indicates that this MAC CE indicate timing advance command for the TAG corresponding to this bit bi (i=0˜7).

In a fourth example, a MAC CE can indicate timing advance commands for one or more TAGS. A bitmap is used to indicate the TAG(s) for which the MAC CE indicates timing advance commands for and then for each indicated TAG, MAC CE can indicate one timing advance command. Table 5 is an example of MAC CE command design is shown below:

TABLE 5

| | | | | | | | | |
|---|---|---|---|---|---|---|---|---|
| b0 | b1 | b2 | b3 | b4 | b5 | b6 | b7 | Oct 1 |

| | |
|---|---|
| Timing Advance Command #1 | Oct 2 |
| . . . | |
| Timing Advance Command #K | Oct K + 1 |

where each bit of b0˜b7 can be used to represent one TAG. Setting the value of bi (i=0˜7)=1 indicates that this MAC CE indicates the timing advance command for the TAG corresponding to this bit bi (i=0˜7). Each of the fields of “Timing Advance Command #1” ˜ “Timing Advance Command #K” indicate one timing advance command for one TAG indicated by the bitmap. The number of K can be equal to the number of bits among b0˜b7 that are set to value 1. For example, the field “Timing Advance Command #k” indicates a timing advance command for the TAG corresponding to the k-th bit among the bits in the bitmap setting to one.

At block 408, the TRP indicates to the terminal device to transmit a PUSCH, PUCCH, or SRS. The terminal device can be requested to transmit a PUSCH, PUCCH or SRS. The terminal device can be provided with two TAGs for one serving cell or BWP: a first TAG and a second TAG. The terminal device can be requested to determine one from the first TAG or the second TAG to adjust the uplink timing of the PUSCH, PUCCH, or SRS transmission according to a timing advance parameter contained in the determined TAG. For one PUSCH transmission, the terminal device can be requested to determine one from the first TAG or the second TAG.

At step 410, if the PUSCH/PUCCH/SRS is associated with the first TRP, the terminal device adjusts the uplink timing of the PUSCH/PUCCH/SRS according to the first timing advance value. If the PUSCH/PUCCH/SRS is associated with the second TRP, the terminal adjusts the uplink timing of the PUSCH/PUCCH/SRS according to the second timing advance value. The terminal device can adjust the uplink timing for the PUSCH transmission based on the timing advance parameters contained in the determined TAG. For one PUCCH transmission, the terminal device can be requested to determine one from the first TAG or the second TAG. The terminal device can adjust the uplink timing for the PUCCH transmission based on the timing advance parameters contained in the determined TAG. For one SRS transmission, the terminal device can be requested to determine one from the first TAG or the second TAG. The terminal device can adjust the uplink timing for the SRS transmission based on the timing advance parameters contained in the determined TAG.

In some implementations, the TAG is associated with a transmission configuration indication (TCI) state used for the uplink transmission. The terminal device can be indicated on joint TCI state or an uplink TCI state for the PUSCH/PUCCH/SRS transmission. The joint TCI state or uplink TCI state provides a reference signal (e.g., one Channel State Information Reference Signal (CSI-RS) resource index, one SS/PBCH (synchronization signal/physical broadcast channel) block index, one SRS resource index) that provides reference for a uplink transit spatial filter. The joint TCI state or uplink TCI state can also be associated with parameters for uplink power control and path loss RS for the transmission of PUSCH, or PUCCH or SRS. One joint TCI state can be associated with a TAG ID. One uplink TCI state can be associated with a TAG ID. If the joint TCI state or uplink TCI state is indicated for PUSCH/PUCCH/SRS transmission, the terminal device can adjust the uplink timing for the PUSCH/PUCCH/SRS transmission according to the timing advance parameters contained in the TAG that is associated with the joint TCI state or uplink TCI state that is indicated for PUSCH/PUCCH/SRS transmission. In another example, a TAG ID can be provided in the joint TCI state. In another example, a TAG ID can be provided in the uplink TCI state.

In some implementations, the TAG is associated with a TCI state used for the uplink transmission. The terminal device can be indicated on the joint TCI state or a uplink TCI state for the PUSCH/PUCCH/SRS transmission. The joint TCI state or uplink TCI state provides a reference signal (e.g., one CSI-RS resource index, one SS/PBCH block index, one SRS resource index) that provides reference for uplink transit spatial filter. The joint TCI state or uplink TCI state can also be associated with parameters for uplink power control and path loss RS for the transmission of PUSCH, or PUCCH or SRS. One joint TCI state can also be associated with an indicator for a TAG configured for the serving cell. One uplink TCI state can also be associated with an indicator for a TAG configured for the serving cell. The terminal device is provided with two TAGs in the serving cell: a first TAG and a second TAG. The indicator in the joint TCI state and uplink TCI state can take the value of 0 or 1, where indicator=0 indicates the first TAG and indicator=1 indicates the second TAG. In another example, if the indicator is not present in the TCI state, that means that the TCI state is associated with the first TAG. If the joint TCI state or uplink TCI state is indicated for PUSCH/PUCCH/SRS transmission, the terminal device can adjust the uplink timing for the PUSCH/PUCCH/SRS transmission according to the timing advance parameters contained in the TAG that is associated with the joint TCI state or uplink TCI state that is indicated for the PUSCH/PUCCH/SRS transmission. In another example, the indicator of the TAG can be provided in the joint TCI state. In another example, the indicator of the TAG can be provided in the uplink TCI state.

In some implementations, for a dynamically scheduled or triggered uplink transmission, the terminal device determines one out of the first TAG and the second TAG based on the associated scheduling DCI. A PUSCH can be scheduled by DCI format 0_0, DCI format 0_1 or DCI format 0_2. If the scheduling DCI format 0_0/0_1/0_2 is received in PDCCH associated with a RRC parameter CORESETPoolindex=0, the terminal device can adjust the uplink timing for the PUSCH based on the timing advance parameters in the first TAG. If the scheduling DCI format 0_0/0_1/0_2 is received in PDCCH associated with a RRC parameter CORESETPoolindex=1, the terminal device can adjust the uplink timing for the PUSCH based on the timing advance parameters in the second TAG.

A PUCCH transmission can be triggered by a DL assignment DCI format 1_1 or DCI format 1_2, for example PUCCH transmission carrying the HARQ-ACK formation to PDSCH or PDCCH. If the DCI format 1_1/1_2 triggering the PUCCH transmission is received in PDCCH associated with a RRC parameter CORESETPoolindex=0, the terminal device can adjust the uplink timing for the PUCCH based on the timing advance parameters in the first TAG. If the DCI format 1_1/1_2 triggering the PUCCH transmission is received in PDCCH associated with a RRC parameter CORESETPoolindex=1, the terminal device can adjust the uplink timing for the PUCCH based on the timing advance parameters in the second TAG.

A periodic SRS transmission can be triggered by a DCI format. If a DCI format triggering the SRS transmission is received in PDCCH associated with a RRC parameter CORESETPoolindex=0, the terminal device can adjust the uplink timing for the SRS based on the timing advance parameters in the first TAG. If a DCI format triggering the PUCCH transmission is received in PDCCH associated with a RRC parameter CORESETPoolindex=1, the terminal device can adjust the uplink timing for the SRS based on the timing advance parameters in the second TAG.

In an example, for PUSCH transmission with a configured grant, a parameter can be provided in RRC configuration for this configured grant and this parameter can indicate one TAG. For a PUSCH transmission with a configured grant, the terminal device can adjust the uplink timing for the PUSCH based on the timing advance parameters of the TAG associated with the configured grant. In one example, for Type 1 PUSCH transmission with a configured grant, a parameter can be provided in RRC configuration for this configured grant and this parameter can indicate one TAG. For a Type 1 PUSCH transmission with a configured grant, the terminal device can adjust the uplink timing for the PUSCH based on the timing advance parameters of the TAG associated with the configured grant.

In one example, for a Type 2 PUSCH transmission with a configured grant, the terminal device can adjust the uplink timing for the PUSCH based on the timing advance parameters of the TAG that is determined based on the DCI triggering this PUSCH transmission. For example, if this DCI is received in PDCCH associated with a RRC parameter CORESETPoolindex=0 or 1, the terminal device can assume to use the first TAG or the second TAG respectively.

FIG. 4B illustrates a diagram 450 of two adjacent uplink transmissions. During the uplink transmission, two adjacent uplink transmissions might overlap in the time domain if the terminal device uses different TAGs to adjust the uplink timing for these two adjacent uplink transmissions. Two PUSCHs are transmitted: PUSCH #1 and PUSCH #2. PUSCH #1 and PUSCH #2 are adjacent in time domain. The terminal device applies TAG 1 on the transmission of PUSCH #1 and TAG2 on the transmission of PUSCH #2. The timing advance adjustment in TAG2 is larger than that in TAG1. Due to that, the starting part of PUSCH #2 overlaps with the last part of the PUSCH #1.

In one method, the terminal device is indicated with a first TAG and a second TAG for uplink transmission in one serving cell. Each PUSCH/PUCCH/SRS transmission can be associated with one of these two TAGs. The terminal device can adjust the uplink timing for each PUSCH/PUCCH/SRS according to the timing advance parameters in the associated TAG. The terminal device is scheduled to transmit a first uplink transmission that is associated with the first TAG. The terminal device is scheduled to transmit a second uplink transmission that is associated with the second TAG. The first uplink transmission and the second uplink transmission are adjacent in time domain. Here the first uplink transmission can be one PUSCH, PUCCH, or SRS and the second uplink transmission can be one PUSCH, PUCCH, or SRS. If the first uplink transmission and the second uplink transmission overlap in time domain due to timing advance command in the first TAG and the second TAG, the terminal device can reduce one of these two uplink transmission in duration relative to the other uplink transmission. In the example of FIG. 4B, the PUSCH #1 and PUSCH #2 overlap in time domain. The terminal device can reduce the PUSCH #1 in duration relative to the PUSCH #2. The terminal device can reduce the PUSCH #2 in duration relative to the PUSCH #1. When the first uplink transmission and the second uplink transmission overlap due to timing advance command in the first TAG and the second TAG, the terminal device can reduce the transmission of one uplink transmission.

In a first example, the terminal device reduces the latter transmission in duration relative to the former transmission. In a second example, the terminal device reduces the former transmission in duration relative to the latter transmission. In a third example, the terminal device reduces the transmission that has lower priority in duration relative to the transmission that has higher priority. The terminal device can determine the priority of the transmission according one or more of the following rules: a PUCCH with HARQ-ACK information can have high priority; PUSCH have higher priority than SRS; and the uplink transmission associated with the first TRP can have higher priority than the uplink transmission associated with the second TRP.

### Example Devices and Systems

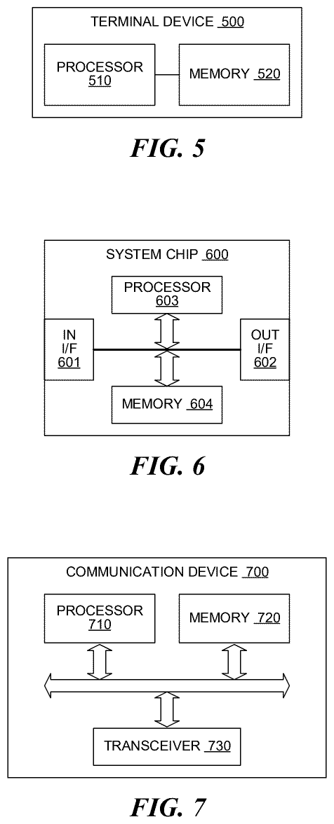

FIGS. 5-7 illustrate example devices and systems that include or incorporate the dynamic power control mechanism described above. FIG. 5 is a schematic block diagram of a terminal device 500 (e.g., an instance of the terminal device 120 of FIG. 1) in accordance with one or more implementations of the present technology. As shown in FIG. 5, the terminal device 500 includes a processing unit 510 (e.g., a DSP, a CPU, a GPU, etc.) and a memory 520. The processing unit 510 can be configured to implement instructions that correspond to the method 400 of FIG. 4A, the diagram 450 of FIG. 4B, and/or other aspects of the implementations described above.

FIG. 6 is a schematic block diagram of a system chip 600 (e.g., a component within the terminal device 120 of FIG. 1 and/or the network device 110 of FIG. 1) in accordance with one or more implementations of the present technology. The system chip 600 in FIG. 6 includes an input interface 601, an output interface 602, a processor 603, and a memory 604 (e.g., a non-transitory, computer-readable medium) that may be connected through an internal communication connection line, where the processor 603 is configured to execute code in the memory 604. The memory 604 can include code that corresponds to the method 400 of FIG. 4A and/or other aspects of the implementations described above. Accordingly, the processor 603 can implement the method 400 of FIG. 4A, the diagram 450 of FIG. 4B, and/or other aspects of the implementations described above.

FIG. 7 is a schematic block diagram of a communications device 700 (e.g., an instance of the terminal device 120 of FIG. 1 and/or the network device 110 of FIG. 1) in accordance with one or more implementations of the present technology. The communications device 700 may include a processor 710, a memory 720, and transceiver 730. The memory 720 may store program code, and the processor 710 may execute the program code stored in the memory 720. The memory 720 can include code that corresponds to the method 400 of FIG. 4A and/or other aspects of the implementations described above. Accordingly, the processor 710 can implement the method 400 of FIG. 4A, the diagram 450 of FIG. 4B, and/or other aspects of the implementations described above.

It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

### EXAMPLES

1. A method for operating a communications device, the method comprising:
receiving, at a terminal device, a first request to transmit a first uplink transmission and a second uplink transmission;
receiving, at the terminal device, a first timing advance group (TAG) and a second TAG for a serving cell,
   wherein the first TAG is associated with a first transmission configuration indication (TCI) state used for the first uplink transmission,
   wherein the second TAG is associated with a second TCI state used for the second uplink transmission;
receiving, at the terminal device, a second request to adjust an uplink timing of at least one of the first uplink transmission or the second uplink transmission;
adjusting the uplink timing of at least one of the first uplink transmission or the second uplink transmission,
   wherein at least one first timing advance parameter included in the first TAG or at least one second timing advance parameter included in the second TAG is adjusted based on the adjusted uplink timing;
transmitting, from the terminal device, the first uplink transmission according to the at least one first timing advance parameter included in the first TAG; and
transmitting, from the terminal device, the second uplink transmission according to the at least one second timing advance parameter included in the second TAG.
2. The method one of example 1, further comprising:
receiving, at the terminal device, a configuration of the serving cell, wherein the configuration includes a first timing advance group identifier (TAG-ID) associated with the first TAG and a second TAG-ID associated with the second TAG,
wherein the first TAG-ID is associated with the first uplink transmission associated with a first transmission-reception point (TRP) and the second TAG-ID is associated with the second uplink transmission associated with a second TRP.
3. The method of any one of examples 1-2, further comprising:
receiving a list of TAG configurations in radio resource control (RRC) signaling, wherein each TAG configuration includes a TAG-ID that identifies a TAG and a time alignment timer for the TAG.
4. The method of any one of examples 1-3,
in response to the first uplink transmission and the second uplink transmission overlapping in a time domain due to a timing advance command in the first TAG or the second TAG, determining a selected uplink transmission from the first uplink transmission and the second uplink transmission;
reducing the selected uplink transmission in duration relative to an unselected uplink transmission,
   wherein the selected uplink transmission is select based on a priority associated with the first uplink transmission or the second uplink transmission.
5. The method of any one of examples 1-4,
wherein the first TCI state or the second TCI state is a joint TCI state or an uplink TCI state,
wherein the joint TCI state or the uplink TCI state provides a reference signal that provides a reference for an uplink transit spatial filter,
wherein the joint TCI state or the uplink TCI state is associated with one or more parameters for uplink power control and a path loss reference signal for the first uplink transmission or the second uplink transmission;
wherein the joint TCI state is associated with a TAG ID, and
wherein the uplink TCI state is associated with a TAG ID.

6. The method of any one of examples 1-5,
wherein the serving cell is associated with the first TAG and the second TAG,
wherein the first TAG is associated with the first uplink transmission of a first TRP in a multi-TRP transmission, and
wherein the second TAG is associated with the second uplink transmission of a second TRP in the multi-TRP transmission.
7. The method of any one of examples 1-6, wherein the first uplink transmission or the second uplink transmission is a Physical Uplink Shared Channel (PUSCH) transmission, a Physical Uplink Control Channel (PUCCH) transmission, or a Sounding Reference Signal (SRS) transmission.
8. A system, comprising:
a terminal device configured to perform a method of any one of examples 1-7, any complementary processes of examples 1-7, any portions of examples 1-7, or a combination thereof.
9. A wireless communications terminal device comprising:
an antenna configured to wirelessly communicate information with a wireless communications network, wherein the terminal device performs a method of any one of examples 1-7, any complementary processes of examples 1-7, any portions of examples 1-7, or a combination thereof.

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1. A method for operating a communications device, the method comprising:
receiving, at a terminal device, a first request to transmit a first uplink transmission and a second uplink transmission;
receiving, at the terminal device, a first timing advance group (TAG) and a second TAG for a serving cell;
wherein the first TAG is associated with a first transmission configuration indication (TCI) state used for the first uplink transmission;
wherein the second TAG is associated with a second TCI state used for the second uplink transmission;
receiving, at the terminal device, a second request to adjust an uplink timing of at least one of the first uplink transmission or the second uplink transmission;
adjusting the uplink timing of at least one of the first uplink transmission or the second uplink transmission;
wherein at least one first timing advance parameter included in the first TAG or at least one second timing advance parameter included in the second TAG is adjusted based on the adjusted uplink timing;
transmitting, from the terminal device, the first uplink transmission according to the at least one first timing advance parameter included in the first TAG; and
transmitting, from the terminal device, the second uplink transmission according to the at least one second timing advance parameter included in the second TAG.

2. The method of claim 1, further comprising:
receiving, at the terminal device, a configuration of the serving cell;
wherein the configuration includes a first timing advance group identifier (TAG-ID) associated with the first TAG and a second TAG-ID associated with the second TAG;
wherein the first TAG-ID is associated with the first uplink transmission associated with a first transmission-reception point (TRP) and the second TAG-ID is associated with the second uplink transmission associated with a second TRP.

3. The method of claim 1, further comprising:
receiving a list of TAG configurations in radio resource control (RRC) signaling, wherein each TAG configuration includes a TAG-ID that identifies a TAG and a time alignment timer for the TAG.

4. The method of claim 1, wherein adjusting the uplink timing of at least one of the first uplink transmission or the second uplink transmission, comprises:
in response to the first uplink transmission and the second uplink transmission overlapping in a time domain due to a timing advance command in the first TAG or the second TAG, determining a selected uplink transmission from the first uplink transmission and the second uplink transmission;
reducing the selected uplink transmission in duration relative to an unselected uplink transmission;
wherein the selected uplink transmission is select based on a priority associated with the first uplink transmission or the second uplink transmission.

5. The method of claim 1, wherein the first TCI state or the second TCI state is a joint TCI state or an uplink TCI state;
wherein the joint TCI state or the uplink TCI state provides a reference signal that provides a reference for an uplink transit spatial filter;
wherein the joint TCI state or the uplink TCI state is associated with one or more parameters for uplink power control and a path loss reference signal for the first uplink transmission or the second uplink transmission;
wherein the joint TCI state is associated with a TAG ID; and
wherein the uplink TCI state is associated with a TAG ID.

6. The method of claim 1, wherein the serving cell is associated with the first TAG and the second TAG;
wherein the first TAG is associated with the first uplink transmission of a first TRP in a multi-TRP transmission; and
wherein the second TAG is associated with the second uplink transmission of a second TRP in the multi-TRP transmission.

7. A system, comprising:
a terminal device configured to perform a process comprising:
receiving a first request to transmit a first uplink transmission and a second uplink transmission;
receiving a first timing advance group (TAG) and a second TAG for a serving cell;
wherein the first TAG is associated with a first transmission configuration indication (TCI) state used for the first uplink transmission;
wherein the second TAG is associated with a second TCI state used for the second uplink transmission;
receiving a second request to adjust an uplink timing of at least one of the first uplink transmission or the second uplink transmission;
adjusting the uplink timing of at least one of the first uplink transmission or the second uplink transmission;
wherein at least one first timing advance parameter included in the first TAG or at least one second timing advance parameter included in the second TAG is adjusted based on the adjusted uplink timing;
transmitting the first uplink transmission according to the at least one first timing advance parameter included in the first TAG; and
transmitting the second uplink transmission according to the at least one second timing advance parameter included in the second TAG.

8. The system of claim 7, wherein the process further comprises:
receiving a configuration of the serving cell;
wherein the configuration includes a first timing advance group identifier (TAG-ID) associated with the first TAG and a second TAG-ID associated with the second TAG;
wherein the first TAG-ID is associated with the first uplink transmission associated with a first transmission-reception point (TRP) and the second TAG-ID is associated with the second uplink transmission associated with a second TRP.

9. The system of claim 7, wherein the process further comprises:
receiving a list of TAG configurations in radio resource control (RRC) signaling, wherein each TAG configuration includes a TAG-ID that identifies a TAG and a time alignment timer for the TAG.

10. The system of claim 7, wherein the process further comprises:
in response to the first uplink transmission and the second uplink transmission overlapping in a time domain due to a timing advance command in the first TAG or the second TAG, determining a selected uplink transmission from the first uplink transmission and the second uplink transmission;
reducing the selected uplink transmission in duration relative to an unselected uplink transmission;
wherein the selected uplink transmission is select based on a priority associated with the first uplink transmission or the second uplink transmission.

11. The system of claim 7, wherein the first TCI state or the second TCI state is a joint TCI state or an uplink TCI state;
wherein the joint TCI state or the uplink TCI state provides a reference signal that provides a reference for an uplink transit spatial filter;
wherein the joint TCI state or the uplink TCI state is associated with one or more parameters for uplink power control and a path loss reference signal for the first uplink transmission or the second uplink transmission;
wherein the joint TCI state is associated with a TAG ID; and
wherein the uplink TCI state is associated with a TAG ID.

12. The system of claim 7, wherein the serving cell is associated with the first TAG and the second TAG;
wherein the first TAG is associated with the first uplink transmission of a first TRP in a multi-TRP transmission; and
wherein the second TAG is associated with the second uplink transmission of a second TRP in the multi-TRP transmission.

13. The system of claim 7, wherein the first uplink transmission or the second uplink transmission is a Physical Uplink Shared Channel (PUSCH) transmission, a Physical Uplink Control Channel (PUCCH) transmission, or a Sounding Reference Signal (SRS) transmission.

14. A wireless communications terminal device comprising:
an antenna configured to wirelessly communicate information with a wireless communications network, wherein the terminal device performs a process comprising:
receiving a first request to transmit a first uplink transmission and a second uplink transmission;
receiving a first timing advance group (TAG) and a second TAG for a serving cell;
wherein the first TAG is associated with a first transmission configuration indication (TCI) state used for the first uplink transmission;
wherein the second TAG is associated with a second TCI state used for the second uplink transmission;
receiving a second request to adjust an uplink timing of at least one of the first uplink transmission or the second uplink transmission;
adjusting the uplink timing of at least one of the first uplink transmission or the second uplink transmission;
wherein at least one first timing advance parameter included in the first TAG or at least one second timing advance parameter included in the second TAG is adjusted based on the adjusted uplink timing;
transmitting the first uplink transmission according to the at least one first timing advance parameter included in the first TAG; and
transmitting the second uplink transmission according to the at least one second timing advance parameter included in the second TAG.

15. The wireless communications terminal device of claim 14, wherein the process further comprises:
receiving a configuration of the serving cell;
wherein the configuration includes a first timing advance group identifier (TAG-ID) associated with the first TAG and a second TAG-ID associated with the second TAG;
wherein the first TAG-ID is associated with the first uplink transmission associated with a first transmission-reception point (TRP) and the second TAG-ID is associated with the second uplink transmission associated with a second TRP.

16. The wireless communications terminal device of claim 14, wherein the process further comprises:
receiving a list of TAG configurations in radio resource control (RRC) signaling, wherein each TAG configuration includes a TAG-ID that identifies a TAG and a time alignment timer for the TAG.

17. The wireless communications terminal device of claim 14, wherein the process further comprises:
in response to the first uplink transmission and the second uplink transmission overlapping in a time domain due to a timing advance command in the first TAG or the second TAG, determining a selected uplink transmission from the first uplink transmission and the second uplink transmission;
reducing the selected uplink transmission in duration relative to an unselected uplink transmission;
wherein the selected uplink transmission is select based on a priority associated with the first uplink transmission or the second uplink transmission.

18. The wireless communications terminal device of claim 14, wherein the first TCI state or the second TCI state is a joint TCI state or an uplink TCI state;
wherein the joint TCI state or the uplink TCI state provides a reference signal that provides a reference for an uplink transit spatial filter;
wherein the joint TCI state or the uplink TCI state is associated with one or more parameters for uplink power control and a path loss reference signal for the first uplink transmission or the second uplink transmission;
wherein the joint TCI state is associated with a TAG ID; and
wherein the uplink TCI state is associated with a TAG ID.

19. The wireless communications terminal device of claim 14, wherein the serving cell is associated with the first TAG and the second TAG;
wherein the first TAG is associated with the first uplink transmission of a first TRP in a multi-TRP transmission; and
wherein the second TAG is associated with the second uplink transmission of a second TRP in the multi-TRP transmission.

20. An integrated circuit chip, comprising:
an integrated logic circuit and/or one an instruction, wherein the integrated chip, when running the integrated logic circuit or the instruction, is caused to perform the method as defined in claim 1.
